(19) United States
(12) Patent Application Publication
(10) Pub. No.: US 2026/0134355 A1
(43) Pub. Date: May 14, 2026

(54) SYSTEM AND METHOD FOR EFFICIENT UTILIZATION OF AMENITIES

(71) Applicant: SENSODRIVE TECHNOLOGY CORP., Vancouver (CA)

(72) Inventor: Mohammadreza PASHA OSKOOIE, Vancouver (CA)

(21) Appl. No.: 18/874,988

(22) PCT Filed: Jul. 12, 2024
(86) PCT No.: PCT/CA2024/050931

§ 371 Date: Dec. 13, 2024

Related U.S. Application Data
(60) Provisional application No. 63/526,687, filed on Jul. 14, 2023.

(51) Int. Cl. G06Q 10/02; G06Q 30/0645

(52) U.S. Cl. CPC G06Q 10/02; G06Q 30/0645

(57) ABSTRACT

A system and method for enabling new and flexible user experiences related to the renting, and making available for rent, many types of underutilized amenities that are necessary for urban life including transportation and storage related amenities are disclosed herein. These amenities include parking spaces, electric vehicle (EV) charging stations, bike racks, storage lockers, meeting spaces. A reservation system hardware, wired and wireless networks and software in the form of an app as well as server side services are utilized to realize the systems and methods.

### TECHNICAL FIELD

The disclosure relates to efficient resource allocation generally, and specifically to a system and method for efficient utilization of amenities.

### BACKGROUND

Urbanization and the ways in which societies adapt to increased urbanization have increasingly important implications for efficient and sustainable use of our resources, particularly in densely populated regions such as cities. Many studies forecast that by 2050, more than two-thirds of the world population will live in urban areas. This will entail a corresponding increase resource consumption including those associated with increased transportation needs such as the number of gas and electric vehicles and bicycles on urban roads, and corresponding demand for related amenities such as parking spaces, temporary bike & storage lockers, and electric vehicle charging stations.

To date, the supply of such amenities has not kept up with the increased demand, particularly during times of increased need for such amenities which may vary over the course of a day, during the week, or seasonally. With increases in demand, such amenities will become increasingly scarce resources, particularly in densely populated settings.

Furthermore, in recent years, governments around the world have renewed their commitment to addressing climate change by reducing carbon emissions which would benefit from utilization of unused or underutilised physical amenities around them. Currently, many such amenities in privately held properties are unused or under-utilized.

Improving the utilization of existing amenities such as, but not limited to, parking spaces is thus beneficial to various stakeholders including owners, drivers, commuters, and ride service providers. Using parking spaces as an example, drivers who are willing to pay to use parking spaces that would otherwise sit vacant represent an opportunity. Such demand for such resources is expected to increase with increasing urbanization.

### SUMMARY OF THE DISCLOSURE

According to an aspect of the present disclosure, there is provided a reservation system comprising: an access control unit in communication with an access gate, the access control unit operable to open the access gate to provide access to an amenity; and a reservation module. The reservation module comprises: a processor, a memory for storing processor executable instructions, and a network interface. The processor is interconnected with the memory and the network interface. The instructions cause the processor to provide: (i) a reservation database storing a plurality of reservation records, wherein each reservation record may comprise a renter identifier field, an amenity identifier field, and a reservation time indicator field; (ii) an amenity registration module for registering amenities from providers, with the reservation module; and (iii) a payment module in communication with the processor for facilitating payment for the amenities. The processor is operable to: receive a request via the network interface comprising a renter identifier, from a mobile device, to open the access gate; verify, using the reservation module, that the request is associated with the renter identifier that is permitted to access the amenity at the time of the request; upon said verifying, send command to the control unit to open the access gate; and otherwise disregard the request, and wherein the access control unit is operable to receive the command, and to open the access gate thereby providing entry access to the amenity.

According to another aspect of the present disclosure, there is provided a method comprising: requesting, using a mobile device, access to a set of amenities; receiving indicators of each amenity in the set of amenities; receiving input selecting a selected one of the amenities; submitting the selected amenity to a reservation module; requesting access to the selected amenity; and upon the request being granted, utilizing the selected one of the amenities.

According to yet another aspect of the present disclosure, there is provided a method of processing a request at a reservation module, the method comprising: receiving the request via the network interface, from a device, to open an access gate to an amenity, the request comprising a renter identifier; verifying, using the reservation module, that the request is associated with the renter identifier that is permitted to access the amenity at the time of the request; upon said verifying, sending a command to an access control unit to open an access gate interconnected to the access control unit, thereby providing entry access to the amenity.

Other technical advantages may become readily apparent to one of ordinary skill in the art after review of the following figures and description.

### BRIEF DESCRIPTIONS OF THE DRAWINGS

For a better understanding of the embodiments described herein and to show more clearly how the embodiments may be carried into effect, reference will now be made, by way of example only, to the accompanying drawings in which:

FIG. 1 is a simplified block diagram of a system that includes a reservation module, an amenity in the form of a parking lot, and an access control unit in communication with an access gate which acts as a barrier to prevent unauthorized vehicles from reaching the parking lot, according to an aspect of the present disclosure;

FIG. 2 a schematic block diagram of several hardware and data forming part of a computing device implementing the reservation module of FIG. 1;

FIG. 3 a schematic block diagram of several hardware components of access control unit of FIG. 1;

FIG. 4 is a flowchart for a method, according to another aspect of the present disclosure, summarizing the activities of the reservation system in processing a request to access an amenity;

FIG. 5 is a user interface diagram displayed by a mobile device interacting with the reservation module of the system of FIG. 1;

FIGS. 6A-6C are example user interface diagrams displayed by a mobile device, when a user registers with the system of FIG. 1 to utilize the reservation system; and po FIG. 7 is a flowchart summarizing steps undertaken by a mobile device of FIG. 1 running a suitable app to allow a driver to access the amenity; and

FIG. 8 is a screenshot, that is an example of the present disclosure, that displays amenities available for rent as part of the steps in FIG. 7.

Unless otherwise specifically noted, articles depicted in the drawings are not necessarily drawn to scale.

### DETAILED DESCRIPTION

The present disclosure relates to a system and method for enabling new and flexible user experiences related to the renting, and making available for rent, of many types of amenities that are necessary for urban life; such types of amenities include transportation and storage related amenities. These amenities typically include but are not limited to: parking spaces, electric vehicle (EV) charging stations, bike racks, storage lockers, meeting spaces.

Embodiments of the system and method disclosed in the present disclosure can be used to address the under-utilization of amenities and resources in an urban setting by providing an online platform on which consumers who wish to access such amenities and owners who are in a position to provide, and wish to provide, access to such amenities can interact with one another.

In space-constrained settings such as urban dwellings, a system that is an example of an embodiment of the presented disclosure, facilitates utilization and monetization of resources that would otherwise be wasted despite high demand for them. For example, private residential parking spaces are often empty during the day on workdays and corporate parking spaces that are typically unused during nights and weekends.

Embodiments of the online reservation system described herein may sometimes be referred to as a SensoDrive™ system. The disclosed system is much more than just a marketplace for consumers to connect with owners. In addition to facilitating such connections, the reservation system, with the consent of the owner, facilitates physical access to such amenities and monitors the usage using sensors to monitor occupancy and perform other checks to ensure compliance to agreements. The embodiments of the described system include software and hardware components as described below with the aid of the drawings.

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

For clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although embodiments are illustrated in the figures and described below, the principles of the present disclosure may be implemented using any number of techniques, whether currently known or not. The present disclosure should in no way be limited to the implementations and techniques illustrated in the drawings and described in this disclosure.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or as a non-limiting example, and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

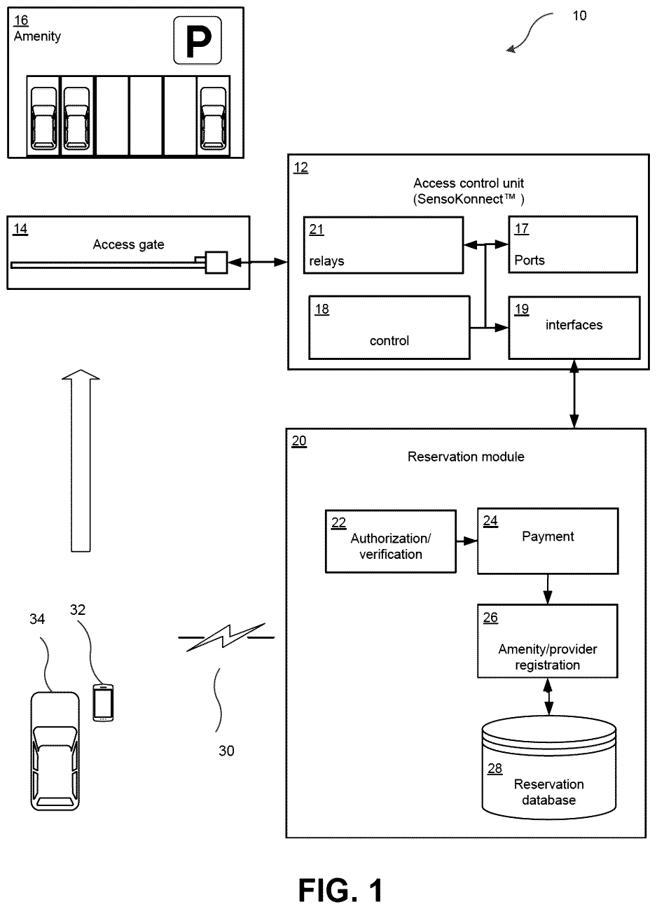

FIG. 1 depicts a system 10 according to an embodiment of a system disclosed herein. System 10 includes an access control unit 12 in communication with an access gate 14 that is a barrier that prevents unauthorized access into an amenity 16.

Access control unit 12 is operable to open access gate 14 in order to provide access to amenity 16 which, in the depicted embodiment, is a parking stall or a parking lot.

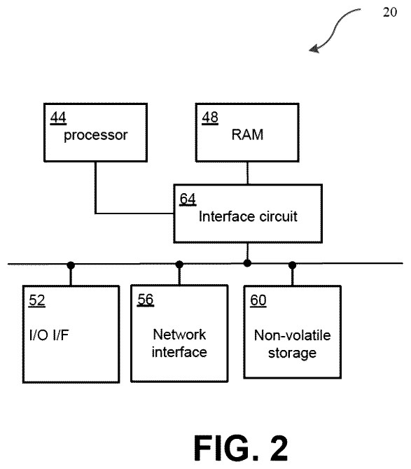

The system 10 also includes a reservation module 20 that includes a processor, memory storing processor executable instructions, and a network interface. The processor, memory and network interfaces are interconnected together and may further be interconnected with other hardware components. A simplified diagram of a computing device implementing hardware components of the reservation module 20 is discussed with reference to FIG. 2. In the depicted embodiment, reservation module 20 is implemented in a networked set of computing devices and cloud services.

Processor executable instructions of the reservation module 20 provide: a reservation database 28 storing reservation records. Each reservation record stored in database 28 can include: a renter identifier field; an amenity identifier field; and reservation time indicator field.

Reservation module 20 includes an amenity registration module 26 for registering amenities from providers, and a payment module 24 for payment processing for facilitating payment for the amenities.

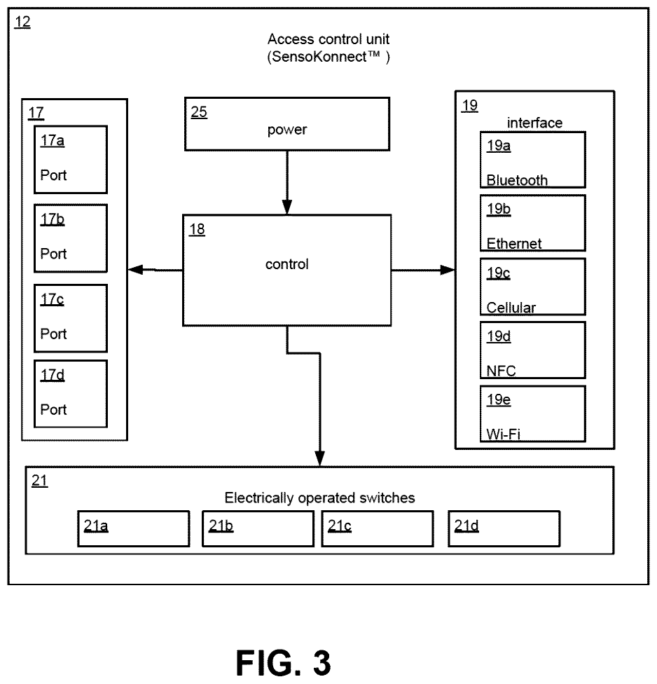

Access control unit 12 includes electrically operated switches 21 (e.g., relays), ports 17, network interfaces 19 and a controller 18 interconnecting the electrically operated switches 21, ports 17, and network interfaces 19 as will be elaborated later with reference to FIG. 3.

The interaction of consumers or renters and owners within system 10 is facilitated software in the form of a mobile application or “app” running on a mobile device such as a mobile device 32 that are in data communication with the reservation system 20 through a data communications network 30.

Access control unit 16 includes hardware components that may include sensors installed at the owner's physical premises. Access control unit 16 facilitates and monitors access to amenities 16 by vehicle 34 of the renter or consumer, at the owner's physical premises to utilize amenity 16.

In the depicted embodiments of the disclosure, the access control unit 16 includes hardware which may be referred to as the SensoKonnect™ hardware, that communicates with a reservation server or reservation module 20 and controls barriers which include gates, garage doors and parking gate arms, to control access to parking spaces and amenities. As noted above, at least one mobile application (e.g., the SensoPass™ mobile app discussed later) allows consumers or renters to locate, reserve, rent, and automatically pay for desired parking and other spaces and amenities. The mobile app may also be used by consumers, managers or owners, each type of user having its own different sequence of signing up and utilizing the app.

FIG. 2 depicts a simplified block diagram of various elements of the access control unit 20. As shown, the access control unit 20 has a number of physical components including a processor 44, which may be the form of a central processing unit (“CPU”), as well as random access memory (“RAM”) 48, an input/output (“I/O”) interface 52, a network interface 56, and non-volatile storage 60.

A high-speed interface circuit 64 enables processor 44 to communicate with the other components. Processor 44 executes processor executable instructions in the form of at least an operating system, and one or more applications including the software modules depicted in FIG. 1.

RAM 48 provides relatively responsive volatile storage to processor 44. I/O interface 52 allows input to be received from one or more peripheral devices, such as a keyboard, a mouse, etc., and outputs information to output devices, such as a display and/or speakers. Network interface 56 permits wired or wireless communication with other computing devices over computer networks such as the Internet.

Non-volatile storage 60 stores the operating system and programs, including computer-executable instructions for implementing the software implemented portions of modules 22, 23, 26, 28 and 29 and associated code, data structures and objects, depicted in FIG. 1. During operation of reservation module 20, the operating system, the programs and the data may be retrieved from non-volatile storage 60 and placed in RAM 48 to facilitate execution.

In operation, reservation module 20 receives one or more requests via the network interface 56 from a mobile device such as mobile device 32 to open the access gate 14 to allow vehicle 24 access to the amenity 16 which in the depicted embodiment of FIG. 1 is a parking stall.

A request can include a renter identifier. The reservation module 20 then verifies that the request is associated with the renter identifier permitted to use amenity 16 at the time of the request and, upon verifying, sends a command to the access control unit 12 to open the access gate 14. If the verification step fails, the request is disregarded by reservation module 20. Alternately, an error message may be sent to the requesting device 32.

Access control unit 12 is operable to receive the command and open the access gate 16 thereby providing entry access to the amenity 16. Upon receiving the command from processor 44 of reservation module 20, access control unit 12 opens the access gate 14 allowing entry to the vehicle 34 into the parking lot of amenity 16.

FIG. 3 is a simplified schematic diagram of the access control unit 12 depicting additional components. As shown, ports 17 of access control unit 12 include a plurality of ports (e.g., ports 17a to 17d) and interface 19 may include interfaces 19a to 19e.

Some or all of ports 17 may be compatible with the RS-485 standard. RS-485 is an industrial specification that defines the electrical interface and physical layer for point-to-point communication of electrical devices. The RS-485 standard allows for long cabling distances in electrically noisy environments and can support multiple devices on the same bus.

In the illustrated embodiment, interface 19a may be a Bluetooth interface; and interface 19b may be an Ethernet port, interface 19c may be a cellular interface for cellular wireless communication, interface 19d may be a near field communication (NFC) interface and interface 19e may be a Wi-Fi interface for communication with a local wireless network. Thus, access control unit 12 may communicate using both wired and wireless networks.

A power supply 25 which may be a battery, supplies power to the circuity of the access control unit 12. The power supply 25 provides a DC power supply.

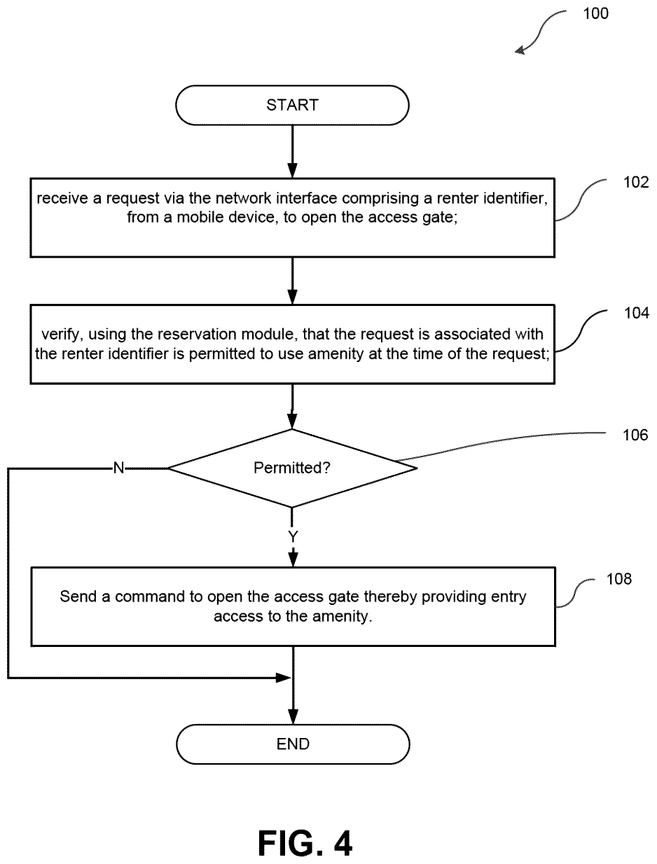

FIG. 4 depicts a flowchart for an Over-The-Air method 100, which summarizes the activities of the reservation system 20 in the above scenario of processing a request to access an amenity.

Over-The-Air method 100 commences with step 102 in which a request is received via the network interface 56 to open the gate 14 to allow entry access to amenity 16. The request can be received from a mobile device such as mobile device 32 to allow parking access to vehicle 34 as shown in FIG. 1.

At step 104, the reservation module 20 verifies that the request is associated with the renter identifier permitted to use amenity at the time of the request. Verification may include validation of the request to ensure security such as checking if the request is initiated from an authorized user and /r device.

At step 106 if successfully verified, the method proceeds to step 108 and a command is sent to the access control unit 12, to open the access gate 14 thereby providing entry access to the parking lot or stall (i.e., amenity 16). The Over-The-Air method 100 then terminates.

If at step 106 the request is not successfully verified, then a command is sent to terminate the request, to skip step 108, and to deny entry access to the amenity 16.

### Registering With the System

In residential towers, both amenity owners and amenity renters, as well as managers, and caretakers register with the reservation module 20 in order to use the system 10. Similarly, a commercial setting, involving operators of fleets, carshares, ride-hails, etc., may register with the reservation module 20 in order to use the system 10. The registration process may be initiated from a client device such as device 32 or another computing device that is in communication with the registration module 20 through predefined application programming interfaces (API).

In a building, a variety of user groups may each have their own sequence of user interface screens and wizards to facilitate the registration. This may be implemented in an app, a web site or on a desktop application having access to the reservation module 20 via a network.

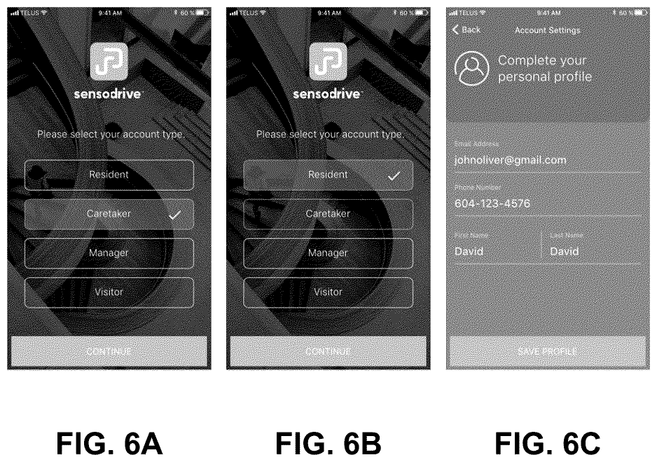

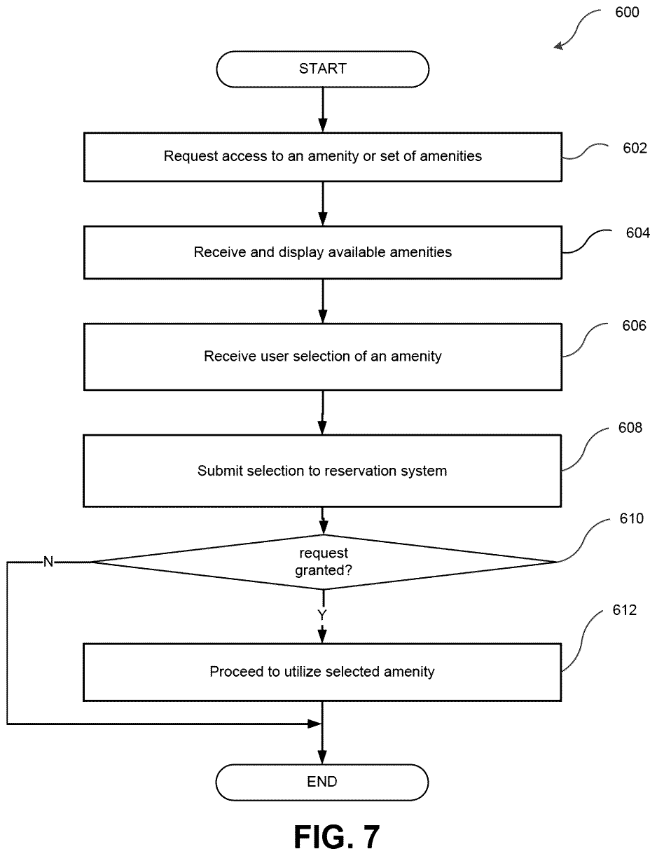

The user interface at first launch is shown in FIG. 6A. The registration screen may begin as depicted in FIG. 6B. After successful registration, the login screen may resemble the illustration shown in FIG. 6C.

### Using the App to Park

In operation, a driver of a vehicle, such as vehicle 34 carrying a driver, may use a mobile device such as device 32 running a client software application or an app executing the client software application to request access to an amenity 16. Amenity 16 may be a parking lot.

An exemplary sequence of events in this use case includes: requesting access via the app on the device 32; receiving and displaying available spots in the one or more parking lots from the reservation module 20; selecting via the app, a parking lot spot among the available spots at the amenity 16 and waiting for gate 14 to be opened; and upon the gate access 14 being opened, then proceeding and parking the vehicle 34 at the selected spot in the parking lot.

FIG. 7 illustrates a method 600 for using the app to request and use an amenity that has been reserved.

At step 602 the method includes the step of requesting, using a mobile device, access to a set of amenities.

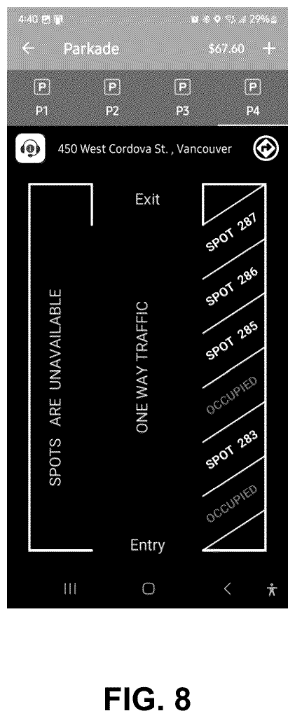

At step 604 the method includes receiving and displaying the amenities on a display. An example of a screenshot displaying a parking lot is shown in FIG. 8.

At step 606 the method includes receiving input selecting a selected one of the amenities.

At step 608 the method includes submitting the selected amenity to a reservation module. At step 610 the method includes the step of checking if the request to use the selected amenity is granted by the reservation module 20.

Having checked that a request is granted, at step 612 the method utilizes the selected one of the amenities. The indication of the request being granted may be provided on the user interface of the mobile device of the renter. Alternately opening of the gate access may indicate permission.

The method then terminates.

Step 604 of displaying available parking lot spots, as received from the reservation module 20 may be graphically presented to scale to mimic the physical layout of the amenity.

Location based services and registration profile data may be utilized to automatically provide some of the inputs required by the app.

### Building Manager

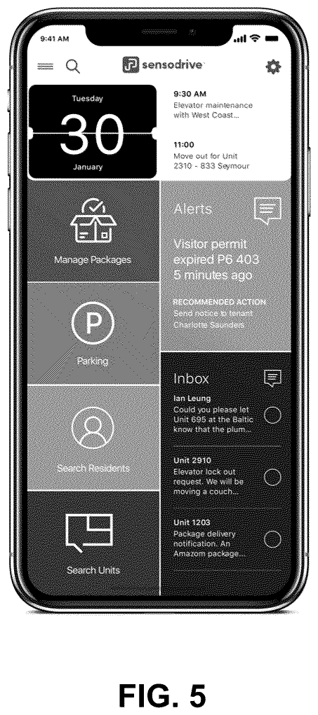

A manager of a building having amenities 16 may utilize an app having a user interface similar to that depicted in FIG. 5 to manage the reservation system. As depicted in the user interface, the app may permit a building manager to search for units, create parking notices, search for residents and the like.

### Other Amenities

Although the reservation module 20 although FIG. 1 was illustrated with a parking lot as an example of an amenity, alternate embodiments of the reservation module 20 may include other types of amenities that include parking, bike cages, storage, lockers at public transit stations and other transit hubs; and the like.

Owners of such reservation system platforms may work with bike sharing companies to increase availability in and around such hubs.

Owners of such reservation system platforms may also work with ride sharing or vehicle sharing companies to increase availability around.

### Benefits

Members that are part of the SensoDrive™ reservation module 20 may be able to smoothly switch between car driving, transit, bikes, and walking thus promote active transport which is beneficial to the environment and has the potential to reduce green house gas (GHG) emissions from individual transport.

The benefits of a reservation system such as system 10 of FIG. 1 may be enhanced by increasing the availability of EV charging station by: installing shared EV charging points in existing and new buildings; installing Class 3 charging stations; and application to delivery fleets to accelerate their shift to zero emission vehicles.

Embodiments of the present disclosure may enable improved facilities management using the depicted hardware and software to control and monetize buildings and amenities, access, and security systems; platform as a service (PaaS) featuring software for providing information and making reservations for temporary lodging and accommodation, temporary storage, temporary parking, temporary charging of electric vehicles, and temporary bicycle storage; platform as a service featuring a computer software platform that facilitates using location information, proximity sensors to optimize the use of under-utilized building amenities in residential, commercial and government properties; application service provider featuring application programming interface (API) for gathering market data; data automation and data collection using software to evaluate, analyze and collect market data in the field of real estate; data automation and data collection using software to evaluate, analyze and collect market data in the field of residential and commercial building management.

The system enables a renter to locate, and open barriers using a mobile device utilizing over the air access which obviates the need for physical contact with buttons or handles, which in turn mitigates the risk of spreading communicable diseases such as covid-19. In addition, the interaction reduces the need for human operators which saves cost and enables operation at any time of the day or night.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A reservation system comprising:
(a) an access control unit in communication with an access gate, the access control unit operable to open the access gate to provide access to an amenity selected from a plurality of amenities;
(b) a reservation module comprising: a processor, a memory for storing processor executable instructions, and a network interface; the processor interconnected with the memory and the network interface; the processor executable instructions causing the processor to provide:
(i) a reservation database storing a plurality of reservation records; each reservation record comprising:
(1) a renter identifier field;
(2) an amenity identifier field; and
(3) a reservation time indicator field;
(ii) an amenity registration module for registering the plurality of amenities with the reservation module, each amenity registered by a corresponding provider, the registering comprising storing data on a physical layout of said each amenity;
(iii) a payment module in communication with the processor for facilitating payment for the amenities;
wherein the processor is operable to:
receive a first request via the network interface comprising a renter identifier from a device to open the access gate;
verify, using the reservation module, that the first request is associated with the renter identifier that is permitted to access the amenity at the time of the first request;
upon said verifying, send command to the control unit to open the access gate; and otherwise disregard the first request, and
wherein the access control unit is operable to receive the command, and to open the access gate thereby providing entry access to the amenity, and
wherein the access control unit is further operable to, upon receiving a second request comprising the renter identifier to open the access gate to exit the amenity and verifying, using the reservation module and a sensor proximate the amenity, that the second request is associated with the renter identifier that is permitted to access the amenity at the time of the second request: (i) open the access gate thereby providing exit access to the amenity; or (ii) otherwise disregard the second request,

2. The system of claim 1, wherein the first request is validated to ensure security.

3. The system of claim 1, wherein the device is a mobile device.

4. The system of claim 1, wherein the first request is received via a predetermined application programming interface (API).

5. The system of claim 1, wherein the access gate communicates with the access control unit using electrically operated switches.

6. The system of claim 5, wherein the access control unit utilizes optical isolation to connect otherwise incompatible devices.

7. The system of claim 1, wherein the second request is received from the device.

8. The reservation system of claim 7, wherein the payment module determines a duration of use of the amenity and computes the cost of using the amenity based on the duration.

9. The reservation system of claim 8, wherein the duration is computed to the nearest minute or second.

10. The reservation system of claim 1, further comprising a payment interface, wherein the access control unit is further operable to request payment authorization from a payment module accessed via the payment interface.

11. The reservation system of claim 1, wherein the amenity is one of a parking space, an electric vehicle (EV) charging station, a bike rack, a storage space, a locker, and a meeting space.

12. A method comprising:
(a) requesting, using a mobile device, access to a set of amenities;
(b) receiving indicators of each amenity in the set of amenities including physical layout data;
(c) receiving input selecting a selected amenity from the set of amenities;
(d) submitting the selected amenity to a reservation module;
(e) requesting access to the selected amenity;
(f) upon the request being granted by having an access gate to the selected amenity being opened, utilizing the selected amenity;
(g) sending a second request, to open the access gate to exit the amenity; and
(h) upon the second requested being verified, using the reservation module and a sensor proximate the amenity, that the second request is associated with a renter identifier that is permitted to access the amenity at the time of the second request, and the access gate is opened, exiting the selected amenity.

13. The method of claim 12 wherein the mobile device comprises a display.

14. The method of claim 12 wherein the request is received using one of an application programming interface (API), web interface, or original equipment manufacturer (OEM) provided interface.

15. The method of claim 12, further comprising registering with the reservation module as a renter, prior to requesting access to the set of amenities.

16. The method of claim 12, further comprising displaying the amenities on a display so as to mimic the physical layout of the amenities.

17. A method of processing a first request and a second request at a reservation module, the method comprising:
(a) receiving the first request via a network interface, from a device, to open an access gate to an amenity, the request comprising a renter identifier;
(b) verifying, using the reservation module, that the first request associated with the renter identifier is permitted to use the amenity at the time of the request;
(c) upon said verifying, sending a command to an access control unit to open an access gate interconnected to the access control unit, thereby providing entry access to the amenity;
(d) receive the second request comprising the renter identifier, from the processor, to open the access gate to exit the amenity;
(e) verify, using the reservation module and a sensor proximate the amenity, that the second request is associated with the renter identifier that is permitted to access the amenity at the time of the second request;
(f) upon said verifying, open the access gate thereby providing exit access to the amenity or otherwise disregard the second request.

18. The method of claim 17, wherein the amenity is one of: a parking spaces, an electric vehicle (EV) charging station, a bike rack, a storage space, a locker, and a meeting space.

19. The method of claim 17 wherein the device is a mobile device.
